(19) United States
(12) Patent Application Publication
(10) Pub. No.: US 2006/0033024 A1
(43) Pub. Date: Feb. 16, 2006

(54) Scanning probe microscopy with inherent disturbance suppression

(76) Inventors: Andrew W. Sparks, Cambridge, MA (US); Scott R. Manalis, Cambridge, MA (US)

Correspondence Address: CHOATE, HALL & STEWART LLP, TWO INTERNATIONAL PLACE, BOSTON, MA, 02110, US

(21) Appl. No.: 11/153,300

(22) Filed: Jun. 15, 2005

Related U.S. Application Data
(60) Provisional application No. 60/579,936, filed on Jun. 15, 2004.

(51) Int. Cl. G01N 23/00

(52) U.S. Cl. 250/306

(57) ABSTRACT

A method for inherently suppressing out-of-plane disturbances in scanning probe microscopy that facilitates higher resolution imaging, particularly in noisy environments.

This application claims the priority of U.S. Provisional Application No. 60/579,936, filed Jun. 15, 2004, the entire contents of which are incorporated herein by reference.

GOVERNMENT RIGHTS

This work was supported by Air Force Office of Sponsored Research (AFOSR) F49620-02-1-0322 and the National Science Foundation (NSF) Center for Bits and Atoms Contract No. CCR-0122419. The U.S. government may have certain rights in this invention.

### FIELD OF THE INVENTION

This application pertains to scanning probe microscopy, and more specifically, to methods and apparatus for reducing the susceptibility of scanning probe microscopes to vibration.

### BACKGROUND OF THE INVENTION

Scanning probe microscopes are notoriously susceptible to disturbances, or mechanical noise, from the surrounding environment that couple to the probe-sample interaction. These disturbances include vibrations of mechanical components as well as piezo drift and thermal expansion. Disturbance effects can be substantially reduced by designing a rigid microscope, incorporating effective vibration isolation, and selecting an appropriate measurement bandwidth and image filter. However, it is not always possible to satisfy these requirements sufficiently, and as a result, critical features in an image can be obscured.

A central problem is that the actuator signal, measured at the output of the feedback controller, is used both to readout topography and correct for disturbances. Abraham et al.¹ have demonstrated disturbance suppression for scanning tunneling microscopy (STM) with an AC modulation technique that measures differential topography. However, the true topography depends on the work function² and requires image reconstruction.³ Schiffer and Stemmer⁴ attached an auxiliary sensor to the microscope and subtracted its signal from the actuator signal. While straightforward to implement, performance of this approach is ultimately governed by the degree of coherence, or similarity, between the disturbance responses of the probe-sample sensor and the auxiliary sensor. Furthermore, the two responses must be subtracted with extreme precision in order to achieve a high common-mode rejection ratio (CMRR).

### SUMMARY OF THE INVENTION

In one aspect, the invention is a method for performing scanning probe microscopy to measure a property of a surface of a sample. The method includes measuring an interaction of a localized probe with a surface and substantially simultaneously measuring a position of the sample with a delocalized sensor. The method may further include providing a reference surface in mechanical communication with the sample; measuring a position may include measuring the position of the reference surface. The localized probe may be a position sensor for an optical lever or an interferometer. The localized probe may include a piezoelectric or piezoresistive material and may be responsive to one or more of a magnetic field at the sample surface, an electric field of the sample surface, a chemical composition of the sample surface, an elasticity of the sample surface, and a topography of the sample surface. Measuring an interaction may include measuring a tunneling current or capacitance between the localized probe and the sample. The delocalized sensor may include an interferometric position sensor. Measuring a position may include measuring a capacitance between the delocalized sensor and a surface disposed under the delocalized sensor, which surface may be the sample surface or a reference surface and mechanical communication with the sample surface. The in-plane resolution of the delocalized sensor may be at least a factor of two, a factor of five, or a factor of 10 coarser than that of the localized probe.

In another aspect, the invention is an apparatus for measuring a property of a sample surface using scanning probe microscopy. The apparatus includes a localized probe that detects the property and a delocalized sensor in mechanical communication with the localized probe.

In another aspect, the invention is an apparatus for measuring a property of a sample surface using scanning probe microscopy. The property exhibits a variation in at least one dimension. The apparatus includes a localized probe having a resolution and a delocalized sensor in mechanical communication with the localized probe. The delocalized sensor is insensitive to the lateral variation of the property at the resolution of the surface probe. The apparatus may further include a cantilever die in mechanical communication with the localized probe and the delocalized sensor. The cantilever die and the localized probe may be fabricated as a single monolithic unit. The cantilever die, the localized probe, and the delocalized sensor may be fabricated as a single monolithic unit. The cantilever die and the delocalized sensor may be fabricated as a single monolithic unit. The delocalized sensor may include a macroscopic plate in mechanical communication with the cantilever die. The macroscopic plate may include a conductive material or an interferometric position sensor. The delocalized sensor may exhibit negligible vibration with respect to the cantilever die. The apparatus may further include a reference surface in mechanical communication with the sample surface. The delocalized sensor may be disposed over the reference surface when the localized probe is disposed over the sample surface. The reference surface may be conductive, reflective, or both.

In another aspect, the invention is an apparatus for measuring a property of a surface of sample using scanning probe microscopy. The apparatus includes a localized probe that interacts with the surface, a delocalized sensor in mechanical communication with the localized probe, and an actuator that displaces the sample roughly perpendicularly to its surface to substantially maintain the magnitude of an interaction between the localized probe and the surface. The delocalized sensor detects a position of the sample. The apparatus may conduct scanning probe microscopy and tapping mode, contact mode, or non-contact mode. The apparatus may further include a reference surface and mechanical communication with the sample, and the delocalized sensor may detect a position of the sample by detecting a position of the reference surface. The actuator may be sensitive to displacement of the localized probe resulting from vibration of a portion of the apparatus, while the delocalized sensor may be substantially insensitive to such displacement.

### BRIEF DESCRIPTION OF THE DRAWING

The invention is described with reference to the several figures of the drawing, in which,

FIG. 1: Operation schematic for inherent disturbance suppression in a scanning probe microscope. The distributed sensor signal, Zₒₚₜ, reveals only topography while the actuator signal, Z_{act}, includes both topography and disturbances. The actuator signal is defined as the controller output, and disturbances are modeled as signals added to the actuator signal.

FIG. 2: Schematic diagram of the response of an exemplary scanning probe microscope according to an embodiment of the invention to A) a change in a topography of a sample and B) a vibration.

FIG. 3: Schematic diagram of a scanning probe microscope with cantilevers according to an embodiment of the invention.

FIG. 4: Scanning electron micrograph of a silicon nitride cantilever with integrated tunneling probe and interferometric position sensor. The cantilever resonant frequency is 50 kHz, and the spring constant at the tunneling tip is estimated to be 15 N/m.

FIG. 5: Schematic diagram of a scanning probe microscope with cantilevers according to an embodiment of the invention in which displacement is measured optically.

FIG. 6: A&B) 500×250 nm² images of a gold sawtooth calibration grating, scanned at 0.5 Hz, in the presence of an artificial disturbance. The disturbance was created by filtering a white noise source with a first-order 35 Hz low-pass filter and adding it to the actuator signal. FIG. 6A shows the actuator signal z_{act} after planefit, and FIG. 6B shows the raw optical signal zₒₚₜ (no planefit). Cross-sections are included for the same scan line. C&D) 400×200 nm² images of Au/Pd/Ti on a silicon substrate. A noisy environment was created by mechanically grounding the optics table while the sample was imaged at a scan rate of 0.2 Hz. Cross-sections from each image are shown for the same scan line.

FIG. 7: Disturbance suppression of the microscope, excited by an artificial sinusoidal disturbance and measured by a lock-in technique. The curves are fit using classical feedback theory for a loop with dynamics only from an integrator.

### DETAILED DESCRIPTION OF CERTAIN PREFERRED EMBODIMENTS

In one embodiment, the invention provides a general approach for inherently suppressing out-of-plane (Z) disturbances in scanning probe microscopy (SPM). In this embodiment, two distinct, coherent sensors measure the probe-sample separation substantially simultaneously. One sensor measures a spatial average distributed over a large sample area while the other responds locally to topography underneath the nanometer-scale probe. When the localized sensor is used to control the probe-sample separation in feedback, the distributed sensor signal reveals only topography. This configuration suppresses disturbances normal to the sample. In an exemplary embodiment, we applied this approach to STM with a microcantilever that integrates a tunneling tip and an interferometric sensor.

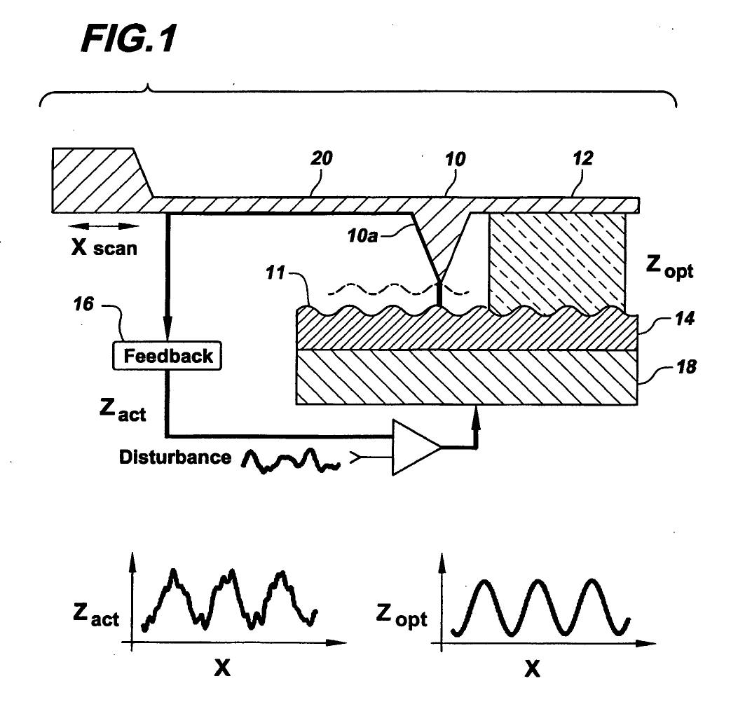

FIG. 1 illustrates Z disturbance suppression with this technique. A first probe 10 is localized by tip 10a to an area smaller than the sample features 11, and is therefore sensitive to the topography. A delocalized sensor 12 distributes this measurement over an area much larger than the features 11, making it insensitive to the topography of sample 14. When a feedback loop 16 is closed around the localized probe 10, the Z actuator 18 will correct for Z disturbances. These corrections will appear in the actuator signal (FIG. 1B) but not at the output of sensors measuring the probe-sample spacing (FIG. 1C). During XY scanning, the actuator will make additional corrections for topography, which will therefore not appear at the localized sensor output. However, these topography corrections originate from changes that the distributed sensor does not detect. As a consequence, the distributed sensor, including delocalized sensor 12, will reveal the sample topography. Therefore, within the feedback bandwidth, the distributed sensor shows only topography, the actuator signal shows topography and disturbances (as in conventional SPM imaging), and the localized sensor shows neither (e.g., the tip 10a is maintained at a constant height from the sample). Disturbance suppression is inherent and no subtraction is necessary.

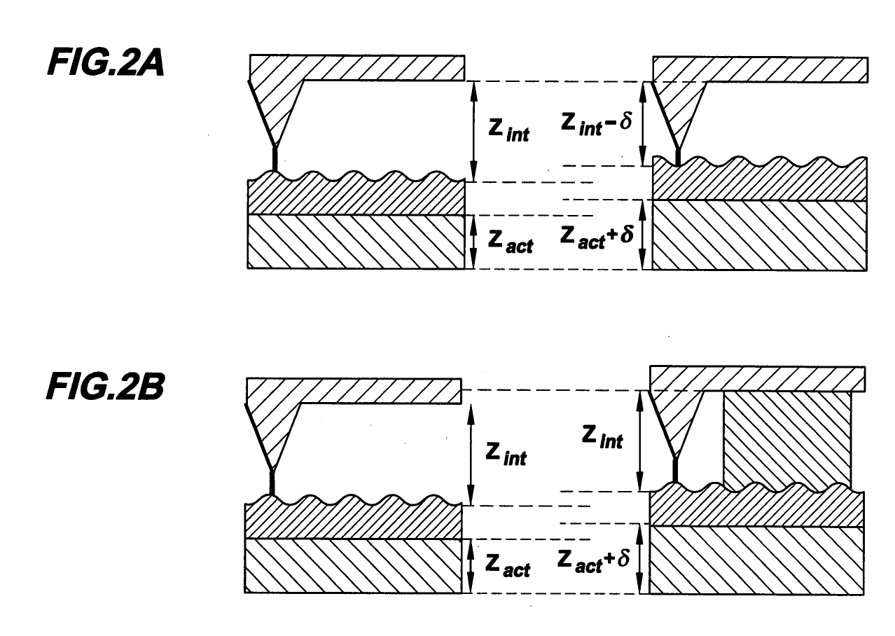

FIG. 2 illustrates the inherent disturbance suppression in more detail for an exemplary embodiment of the invention. FIG. 2A shows how the dual sensor is used to measure topography. Feedback loop 16 is used to maintain the sample features 11 at a constant distance from tip 10a. To do this, the actuator moves the sample 14 through a distance delta in the Z direction. Delocalized sensor 12 is sensitive to the movement through distance delta of the entire sample 14. The sensor output indicates the topography of the sample surface even though the variation in the topography was detected by a different sensor, localized probe 10.

FIG. 2B shows how the delocalized sensor inherently suppresses Z disturbances. Z disturbances move both the localized probe 10 and delocalized sensor 12, which, in this embodiment, are supported by a common cantilever 20. The actuator 18 responds to the disturbance by moving sample 14 to maintain a constant separation between sample features 11 and tip 10a. As a result, delocalized sensor 12 does not detect the disturbance.

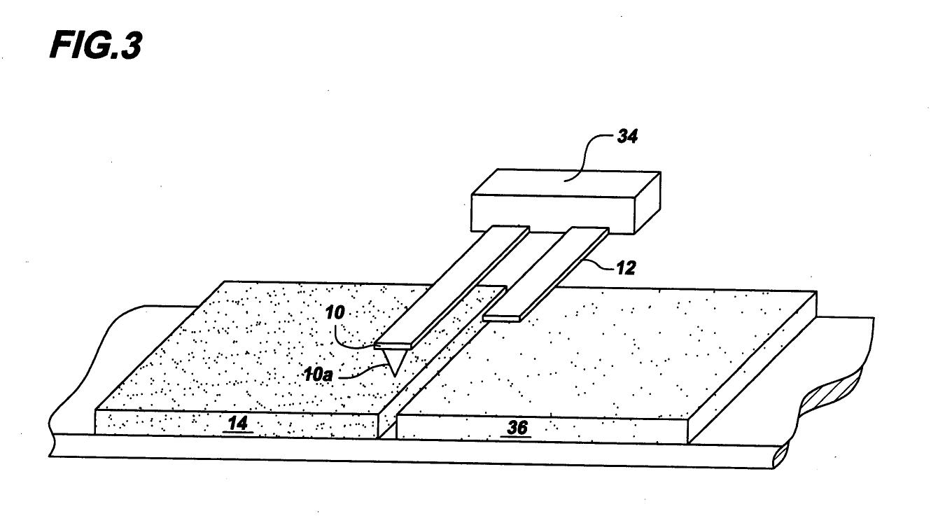

An exemplary embodiment of this concept is shown in FIG. 3. Localized probe 10 and delocalized sensor 12 are each mechanically connected to cantilever die 34. Localized probe 10 and delocalized sensor 12 may be fabricated as a monolithic unit with die 34 or using any technique commonly used to fabricate probes for SPM. For example, the delocalized sensor 12 may be a macroscopic electrode or a partial mirror that is attached to the cantilever die 34 or its support. The localized probe 10 may be fabricated as any conventional SPM probe. For example, it may be flexible or stiff, depending on the desired imaging mode. The interaction of the tip 10a with the sample may be detected optically, for example, using an optical lever or interferometry, or electrically, for example, by measuring tunneling current, a capacitance, or by exploiting piezoelectric or piezoresistive properties of the sensor material. The delocalized sensor 12 is stiff and does not bend. Thus, its motion is detected through techniques that do not require deflection, e.g., interferometry or capacitance measurements.

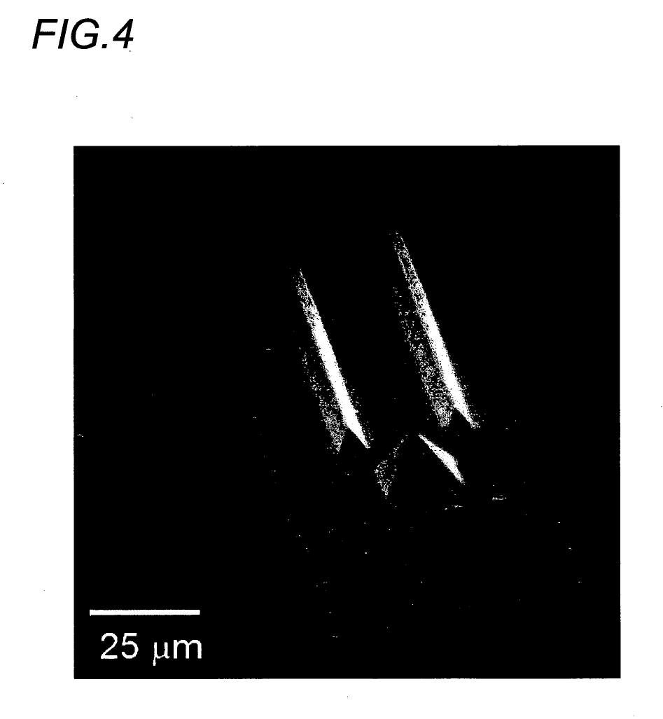

A scanning electron micrograph of an exemplary integrated silicon nitride cantilever with a localized tunneling probe and a distributed interferometric sensor is shown in FIG. 4. The interferometer includes an array of slits that is illuminated with a focused laser beam while an optically smooth sample is scanned underneath the cantilever. Light traveling through the slits reflects from the sample and interferes with light reflected from the cantilever, creating a phase sensitive diffraction grating.⁵ The probe-sample separation is determined by measuring the intensity of a diffracted mode,⁶ which varies sinusoidally with separation.⁷ Due to the spot size of the laser, the resulting separation measurement is an effective average over an area of, for example, 500 μm². The area may be adjusted by changing the spot size of the laser. The tunneling probe, on the other hand, measures the separation over as little as 1 nm².⁸ Both sensors are used to measure the separation between the sample and a particular location along the cantilever. Although these cantilever locations differ for each sensor, they are rigidly connected to ensure high Z coherence between the two sensor signals. Since interaction forces between the probe and sample can be quite large,⁹ two hollow, longitudinal “fins” were used to stiffen the cantilever by increasing its effective thickness. The cantilever is fabricated by a well established process where the tip and fins are simultaneously defined by etching silicon anisotropically with potassium hydroxide.¹⁰ Cantilevers were subsequently coated with an electron-beam evaporated Ti/Pd/Au multilayer film for tunneling and reflectivity purposes.¹¹

The delocalized sensor 12 need not be physically close to or even in the same planar location as the localized probe 10; however, the closer they are, the more similar the vibrations experienced by the two sensors will be, increasing the ability of the apparatus to suppress out-of-plane disturbances in the signal generated in response to the motion of localized probe 10. The delocalized sensor 12 may be disposed over the sample itself or may be disposed over a reference surface 36 (FIG. 3), e.g., a mirror or electrode, whose surface may or may not be coplanar or even substantially parallel with that of the sample 14. Where the sample 14 has appropriate electrical or optical properties (e.g., it exhibits similar conductivity or reflectance to a potential reference surface), the reference surface may not be necessary. Whether the reference surface 36 is co-planar with sample 14 or is omitted entirely, the delocalized sensor 12 may be at the exact same height or a different height as localized probe 10. For example, the separation of delocalized sensor 12 and sample 14 may be about the same as the tip height, e.g., about 20 microns. Since delocalized sensor 12 is fabricated without a tip, then the feedback mechanism that adjusts the height of the localized probe 10 will prevent the delocalized sensor from touching the sample 14 or reference surface 36. However, the height of the delocalized sensor above the sample or reference surface may be much greater than that of the localized probe, for example, up to several millimeters or more. Of course, where the reference surface 36 is not coplanar with sample 14, the separation of delocalized sensor 12 and the reference surface may be determined arbitrarily, so long as it is greater than the expected change in the separation between localized probe 12 and the sample 14 as it is scanned.

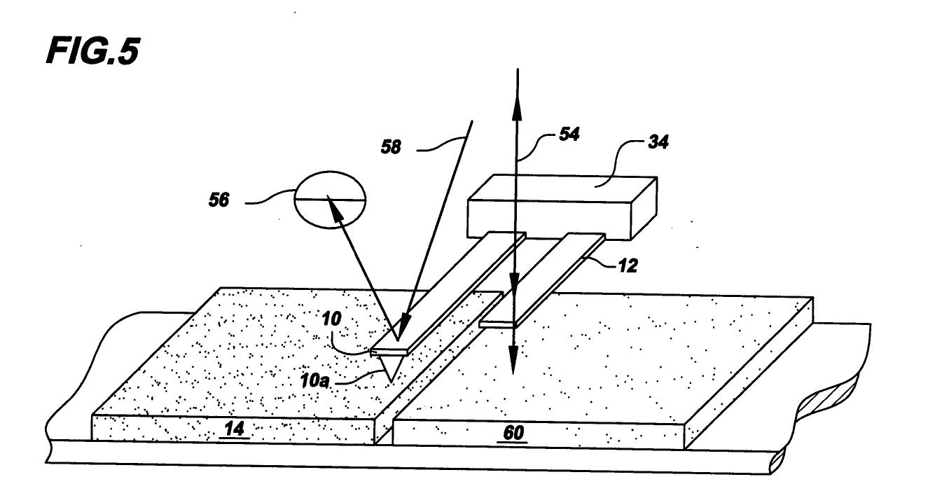

FIG. 5 shows an embodiment of the invention in which the displacement of both the localized probe 10 and the delocalized sensor 12 are detected optically. In this embodiment, localized probe 10 is a silicon cantilever used for tapping mode AFM. It has a length of about 200 micron and a thickness of about 3 micron, and is about 50 micron wide. One skilled in the art will recognize that localized probe 10 may be fabricated from any material and in any size that is appropriate for the particular scanning probe microscopy technique being used. In this embodiment, delocalized sensor 12 is a macroscopic mirror attached to the cantilever die 34 or its support. The delocalized sensor may be about 3 mm long, 1 mm wide, and 0.5 mm thick. One skilled in the art will recognize that the delocalized sensor may have different dimensions and that the optimal dimensions will depend on the material from which the cantilever is made and the optical instrumentation used to detect its displacement. In general, the delocalized sensor may be sufficiently thick that it does not vibrate as the cantilever die is displaced and sufficiently wide to accommodate the laser beam 54 from an interferometer. This will depend on, for example, the elastic modulus of the sensor material and the length of the cantilevered portion of the delocalized sensor 12.

In FIG. 5, the displacement of localized probe 10 with respect to the sample features is detected using an optical lever including split photodiode 56. A laser beam 58 is reflected from localized probe 10 to split photodiode 56, which is precisely aligned so that the reflected beam 58 is incident on the center of the photodiode 56 when the probe is at a predetermined height with respect to the sample features 11. If the interaction between the localized probe 10 and the sample features 11 causes the localized probe to be displaced with respect to the sample features 11, the reflected beam will be deflected from the center of photodiode 56. A feedback loop is used to displace the sample 14 so that the height of tip 10a above the sample features 11 remains substantially constant. The incident beam 58 may be small, e.g., about 10 microns in diameter. The use of optical levers is well known, and those skilled in the art will recognize that the beam size may be varied if desired.

In FIG. 5, the displacement of the delocalized sensor 12 with respect to mirror 60 is measured by interferometry. Instead of a tip, delocalized sensor 12 may include a diffraction grating or a partially reflective mirror. The grating may include cut slots or a pattern of reflective strips on the surface of the delocalized sensor. The height of the delocalized sensor 12 with respect to the mirror 60 is determined by analyzing the interference pattern generated as a laser beam is reflected from both the delocalized sensor and the mirror. The resolution of delocalized sensor 12 is sufficiently coarse that it is insensitive to the sample features 11 that are measured using localized probe 10. For example, delocalized sensor 12 may have a lateral resolution that is at least two times, at least five times, at least 10 times, at least 50 times, or at least 100 times coarser than that of localized probe 10. Nonetheless, the out-of-plane resolution of delocalized sensor 12 may be quite fine, on the scale of the resolution of localized probe 10, e.g. a few nanometers or less, for example, atomic resolution. As shown in FIG. 5, the motion of localized probe 10 is detected using a laser beam having a spot size of about 10 micron. The spot size of beam 54 need only be larger than the lateral dimension of sample features 11, although larger spots may certainly be used, e.g., about 1 mm across. Generally, the spot size should be bigger than the in-plane, lateral dimension of the relevant features of the surface from which the laser beam is being reflected to reduce beam loss from off-axis reflections. The difference in spot size between the two sensors may be achieved by focusing the laser beam for the optical laser while collimating the beam for the interferometer.

In another embodiment, the teachings of the invention may be used to measure properties of a sample surface aside from topography and using other variants of scanning probe microscopy. For example, the techniques of the invention may be applied to contact mode, non-contact mode, and tapping mode scanning probe techniques. In general, the delocalized sensor may be used to detect the out-of-plane displacement of the sample with respect to the localized probe in any imaging mode where a feedback mechanism is used to maintain the magnitude of an interaction of the localized probe with the sample features. The interaction of the localized probe with the sample need not be related to topography. One skilled in the art will recognize that different localized probes may be required to measure a particular sample property. One of the advantages of the invention is that the structure of the second probe is independent of the interaction between the localized probe and the sample features.

For example, the localized probe may be used to measure the elasticity of a surface. Alternatively or in addition, the electric field or magnetic field associated with a sample surface may be characterized using a conductive or magnetic tip, respectively. Alternatively, a tip may be coated with a conductive or magnetic material. In another embodiment, the chemical structure of a surface may be characterized using a localized probe that is sensitive to non-covalent interactions such as electrostatic interactions, magnetic interactions, hydrogen bonding, and van der Waals forces. The chemistry of the localized probe may be adjusted to enable it to participate in the desired interaction. For example, the tip may be functionalized with a particular ionic or polar functionality using techniques known to those skilled in the art. Tips may be purchased commercially from companies such as Pacific Nanotechnologies (Santa Clara, Calif.) and Veeco Instruments (Woodbury, N.Y.). Methods of producing tips are well known to those skilled in the art and are discussed in references such as Liou, et al., “Development of high coercivity magnetic force microscopy tips,” J. Magn. Magn. Mater., 1998, 190:130-134, and Noy, et al., “Chemical Force Microscopy,” Annual Review of Materials Science, 1997, 27:381-421, the entire contents of both of which are incorporated herein by reference.

### EXAMPLE

All measurements were performed on a home-built STM that was not optimized for vibration isolation or mechanical rigidity. The cantilever and sample were magnetically mounted on a Z piezo stack (Thorlabs, AE0203D04) and XY unimorph scanner,¹² respectively. Tunneling current was detected with a commercial current amplifier (RHK, IVP-200). A simple analog integral controller was used to stabilize the tunneling current. The controller output, or actuator signal, was amplified by a power amplifier before being sent to the actuator. The feedback bandwidth was limited to below 1 kHz by the Z resonance of the XY scanner. Light from a diode laser was focused onto the cantilever slits with an achromatic lens, and the diffracted mode intensity was measured with a large-area reverse-biased photodiode (Thorlabs, DET110). The short optical pathlength difference of the 15 μm deep grating minimizes effects of refractive index fluctuations in air and phase noise of the laser that limit the resolution of interferometers. Both the sample and the lens were mounted on three-axis translation stages. We have found the optical readout to be insensitive to vibrations of the laser, lens, and photodiode. The entire assembly was covered in an acoustically isolating box on a floating optics table.

The system was engaged in tunneling feedback with a computer-controlled stepper motor. Because of the non-linear dependence of the mode intensity on separation, the interferometer was biased at a point of maximum slope to achieve maximum sensitivity. This bias was adjusted in tunneling feedback either by moving the laser spot position on the grating or by changing the XY offset of the sample relative to the tunneling probe. The actuator and optical signals were processed by anti-aliasing filters before being recorded by LabVIEW. Images from the actuator signal were planefit offline to remove effects of sample tilt. This operation was not necessary for the optical signal, allowing image acquisition at higher signal gain. The optical signal was calibrated either from the known response of the Z piezo or by relating the displacement response of the interferometer to the wavelength of illumination.¹³

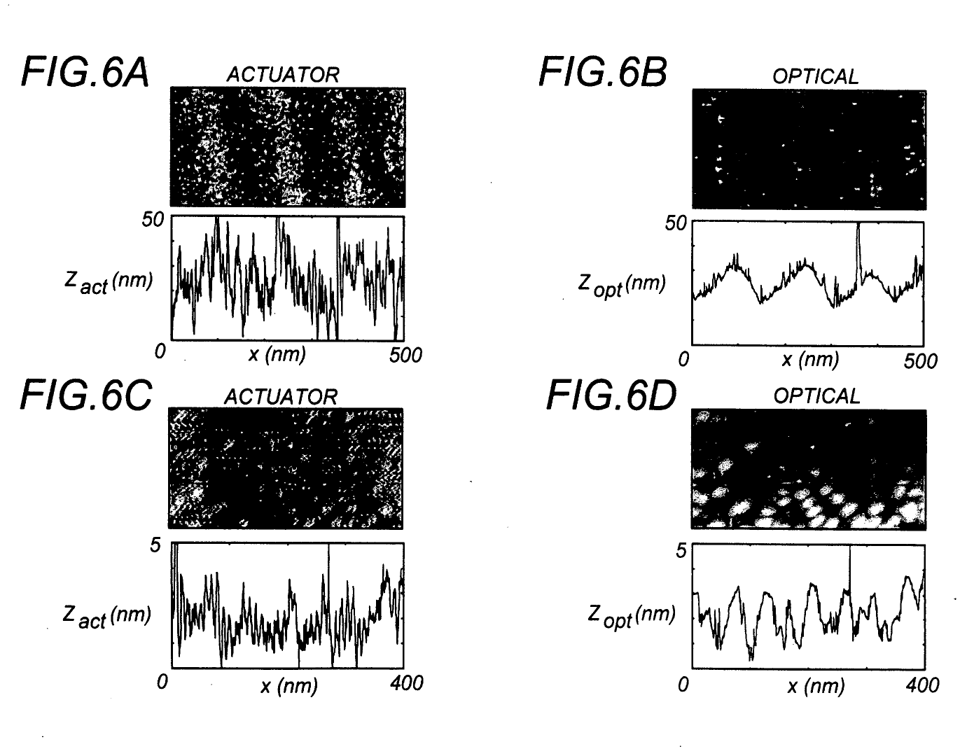

FIG. 6 shows images of a gold sawtooth calibration grating that were acquired in the presence of an artificial disturbance. This disturbance was created by filtering a white noise source with a first-order 35 Hz low-pass filter and adding it to the actuator signal. In FIG. 6A, the actuator signal shows the signature of the disturbance to the extent that the grating lines are barely visible. In FIG. 6B, the optical signal shows strong suppression of the noise, especially at low frequencies, and allows clear identification of the sawtooth profile. In FIGS. 6C (actuator signal) and 6D (optical signal), the artificial disturbance is turned off and a flat gold film was imaged while the optics table was mechanically grounded. Exposed to fourth floor building vibrations and with ten times less topography than the calibration grating, many grains are unresolvable in the actuator signal. The optical signal, however, reveals them with clarity.

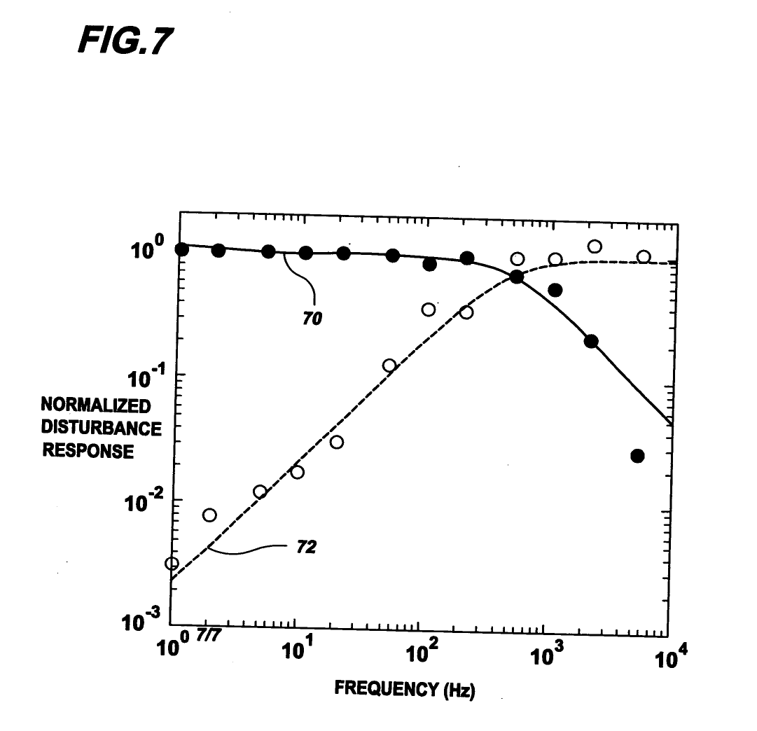

To quantify the suppression capabilities of this system, we created single frequency disturbances by adding a sinusoidal voltage to the actuator signal. These disturbances were kept between 10 and 50 nm, well above the noise floor of the sensors but within the linear operating regime of the optical sensor. Both actuator signal 70 and optical signal 72 were monitored by lock-in amplifiers; their steady state amplitudes are recorded in FIG. 7. Curves were fit using classical feedback theory for a simplified feedback loop with only an integrator, gain, and a closed-loop bandwidth of 500 Hz.¹⁴ A CMRR of 54 dB was achieved at 1 Hz, the lowest frequency measured, compared to 0 dB with conventional imaging. The CMRR decreased linearly with frequency up to the feedback bandwidth and will increase linearly with the bandwidth.

It is important to note that higher resolution images on this microscope were not possible due to disturbances in X and Y. As a result, small features, especially when acquired at slow scan rates, tended to be smeared out. However, by incorporating this device into a more stable and better isolated microscope, we can expect image resolution to be limited only by the noise of the interferometer, estimated at 0.02 Å in a bandwidth of 10 Hz-1 kHz,⁶ and the noise of the tunneling process, estimated at less than 0.1 A in the same bandwidth.^{1,2} Such a microscope would have lateral resolution comparable to a conventional STM but maintain the same high CMRR in Z that we have achieved in this work. Furthermore, this instrument could be developed for a complementary application: optical feedback with tunneling readout, enabling closed-loop, constant-height tunneling spectroscopy. This previously unattainable mode could allow chemical identification on the molecular scale in a variety of experimental conditions, including aqueous environments.

### REFERENCES

1. D. W. Abraham, C. C. Williams, and H. K. Wickramasinghe, Appl. Phys. Lett. 53, 1503 (1988).

2. S. Sugita, Y. Mera, and K. Maeda, J. Appl. Phys. 79, 4166 (1996).

3. E. P. Stoll and J. K. Gimzewski, J. Vac. Sci. Technol. B 9, 643 (1991).

4. G. Schitter and A. Stemmer, Nanotechnology 13, 663 (2002).

5. O. Solgaard, F. S. A. Sandejas, and D. M. Bloom, Opt. Lett. 17, 688 (1992).

6. S. R. Manalis, S. C. Minne, A. Atalar, and C. F. Quate, Appl., Phys. Lett. 69, 3944 (1996).

7. N. A. Hall and F. L. Degertekin, Appl. Phys, Lett. 80, 3859 (2002).

8. P. K. Hansma and J. Tersoff, J. Appl. Phys. 61, R1 (1987).

9. D. Erts, A. Lohlnus, R. Lohmus, H. Olin, A. V. Pokropivny, L. Ryen, and K. Svensson, Appl, Surf. Sci. 188, 460 (2002).

10. T. R. Albrecht, S. Akamine, T. E. Carver, and C. F. Quate, J. Vac. Sci. Technol. A 8, 3386 (1990).

11. T. W. Kenny, W. J. Kaiser, H. K. Rockstad, J. K. Reynolds, J. A. Podosek, and E. C. Vote, IEEE J. MEMS 3, 97 (1994),

12. J. D. Alexander, http://www.geocities.com/spm_stmn/Project.html

13. G. G. Yaralioglu, A. Atalar, S. R. Manalis, and C. F. Quate, J. Appl. Phys. 83, 7405 (1998).

14. G. F. Franklin, J. D. Powell, and A. Emami-Naeini, Feedback Control of Dynamic Systems, 3rd ed. (Addison-Wesley, Reading, Mass., 1994).

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method for performing scanning probe microscopy to measure a property of a surface of a sample, comprising:
measuring an interaction of a localized probe with the surface; and
substantially simultaneously measuring a position of the sample with a delocalized sensor.

2. The method of claim 1, further comprising providing a reference surface in mechanical communication with the sample, and wherein measuring a position comprises measuring the position of the reference surface.

3. The method of claim 1, wherein the localized probe is a position sensor for an optical lever or an interferometer.

4. The method of claim 1, wherein the localized probe comprises a piezoelectric or piezoresistive material.

5. The method of claim 1, wherein the localized probe is responsive to one or more of a magnetic field at the sample surface, an electric field at the sample surface, a chemical composition of the sample surface, and an elasticity of the sample surface.

6. The method of claim 1, wherein the localized probe is responsive to a topography of the sample surface.

7. The method of claim 1, wherein measuring an interaction comprises measuring a tunneling current or a capacitance between the localized probe and the sample.

8. The method of claim 1, wherein the delocalized sensor includes an interferometric position sensor.

9. The method of claim 1, wherein measuring a position comprises measuring a capacitance between the delocalized sensor and a surface disposed under the delocalized sensor.

10. The method of claim 9, wherein the surface disposed under the delocalized sensor is the sample surface or a reference surface in mechanical communication with the sample surface.

11. The method of claim 1, wherein the in-plane resolution of the delocalized sensor is at least a factor of two coarser than that of the localized probe.

12. The method of claim 1, wherein the in-plane resolution of the delocalized sensor is at least a factor of 5 coarser than that of the localized probe.

13. The method of claim 1, wherein the in-plane resolution of the delocalized sensor is at least a factor of 10 coarser than that of the localized probe..

14. An apparatus for measuring a property of a sample surface using scanning probe microscopy, comprising:
a localized probe that detects the property; and
a delocalized sensor in mechanical communication with the localized probe.

15. An apparatus for measuring a property of a sample surface using scanning probe microscopy, the property exhibiting a variation in at least one dimension, comprising:
a localized probe having a resolution; and
a delocalized sensor in mechanical communication with the localized probe,
wherein the delocalized sensor is insensitive to the lateral variation of the property at the resolution of the surface probe.

16. The apparatus of claim 14, further comprising a cantilever die in mechanical communication with the localized probe and the delocalized sensor.

17. The apparatus of claim 16, wherein the cantilever die and the localized probe are fabricated as a single monolithic unit.

18. The apparatus of claim 16, wherein the cantilever die, the localized probe, and the delocalized sensor are fabricated as a single monolithic unit.

19. The apparatus of claim 16, wherein the cantilever die and the delocalized sensor are fabricated as a single monolithic unit.

20. The apparatus of claim 16, wherein the delocalized sensor comprises a macroscopic plate in mechanical communication with the cantilever die.

21. The apparatus of claim 20, wherein the macroscopic plate comprises a conductive material or an interferometric position sensor.

22. The apparatus of claim 16, wherein the delocalized sensor exhibits negligible vibration with respect to the cantilever die.

23. The apparatus of claim 14, wherein the localized probe is responsive to one or more of a magnetic field at the sample surface, an electric field at the sample surface, a chemical composition of the sample surface, and an elasticity of the sample surface.

24. The apparatus of claim 14, wherein the localized probe is responsive to a topography of the sample surface.

25. The apparatus of claim 14, further comprising a reference surface in mechanical communication with the sample surface, wherein the delocalized sensor may be disposed over the reference surface when the localized probe is disposed over the sample surface.

26. The apparatus of claim 25, wherein the reference surface is conductive, reflective, or both.

27. The apparatus of claim 14, wherein the localized probe is a position sensor for an optical lever or an interferometer.

28. The apparatus of claim 14, wherein the localized probe comprises a piezoelectric or piezoresistive material.

29. The apparatus of claim 14, wherein at least one of the localized probe and delocalized sensor comprises a conductive material.

30. The apparatus of claim 14, wherein the delocalized sensor comprises an interferometric position sensor.

31. The apparatus of claim 14, wherein the in-plane resolution of the delocalized sensor is at least a factor of two coarser than that of the localized probe.

32. The apparatus of claim 14, wherein the in-plane resolution of the delocalized sensor is at least a factor of 5 coarser than that of the localized probe.

33. The apparatus of claim 14, wherein the in-plane resolution of the delocalized sensor is at least a factor of 10 coarser than that of the localized probe.

34. An apparatus for measuring a property of a surface of a sample using scanning probe microscopy, comprising:
a localized probe that interacts with the surface;
a delocalized sensor in mechanical communication with the localized probe; and
an actuator that displaces the sample roughly perpendicularly to its surface to substantially maintain the magnitude of an interaction between the localized probe and the surface,
wherein the delocalized sensor detects a position of the sample.

35. The apparatus of claim 34, wherein the localized probe is responsive to one or more of a magnetic field at the sample surface, an electric field at the sample surface, a chemical composition of the sample surface, and an elasticity of the sample surface.

36. The apparatus of claim 34, wherein the localized probe is responsive to a topography of the sample surface.

37. The apparatus of claim 34, wherein the apparatus conducts scanning probe microscopy in tapping mode, contact mode, or non-contact mode.

38. The apparatus of claim 34, further comprising a cantilever die in mechanical communication with the localized probe and the delocalized sensor.

39. The apparatus of claim 38, wherein the cantilever die and the localized probe are fabricated as a single monolithic unit.

40. The apparatus of claim 38, wherein the cantilever die, the localized probe, and the delocalized sensor are fabricated as a single monolithic unit.

41. The apparatus of claim 38, wherein the cantilever die and the-delocalized sensor are fabricated as a single monolithic unit.

42. The apparatus of claim 38, wherein the delocalized sensor comprises a macroscopic plate in mechanical communication with the cantilever die.

43. The apparatus of claim 42, wherein the macroscopic plate comprises a conductive material or an interferometric position sensor.

44. The apparatus of claim 38, wherein the delocalized sensor exhibits negligible vibration with respect to the cantilever die.

45. The apparatus of claim 34, further comprising a reference surface in mechanical communication with the sample surface, wherein the delocalized sensor detects the position of the sample by detecting a position of the reference surface.

46. The apparatus of claim 45, wherein the reference surface is conductive, reflective, or both.

47. The apparatus of claim 34, wherein the actuator is sensitive to displacement of the localized probe resulting from vibration of a portion of the apparatus, and wherein the delocalized sensor is substantially not.

48. The apparatus of claim 34, wherein the in-plane resolution of the delocalized sensor is at least a factor of two coarser than that of the localized probe.

49. The apparatus of claim 34, wherein the in-plane resolution of the delocalized sensor is at least a factor of 5 coarser than that of the localized probe.

50. The apparatus of claim 34, wherein the in-plane resolution of the delocalized sensor is at least a factor of 10 coarser than that of the localized probe.
